(19) United States
(12) Patent Application Publication
(10) Pub. No.: US 2024/0144287 A1
(43) Pub. Date: May 2, 2024

(54) PROCESS AND SYSTEM FOR REPURPOSING NON-TRANSFERABLE AIR TRAVEL INVENTORY

(71) Applicant: Edna Catalina Ruiz Trevino, New York, NY (US)

(72) Inventor: Edna Catalina Ruiz Trevino, New York, NY (US)

(21) Appl. No.: 18/405,663

(22) Filed: Jan. 5, 2024

Related U.S. Application Data
(63) Continuation-in-part of application No. 16/431,820, filed on Jun. 5, 2019, now abandoned.
(60) Provisional application No. 62/680,686, filed on Jun. 5, 2018.

(51) Int. Cl. G06Q 20/40; G06Q 10/02

(52) U.S. Cl. CPC G06Q 20/407; G06Q 10/02

(57) ABSTRACT

An air travel repurposing system including a digital platform configured to be accessed only by registered users is disclosed. The repurposing system enables registered platform users, when the platform is operatively connected to a global distribution system, to access data associated with certain booked reservations of first users registered with the platform. A new air travel inventory is generated when a booked air traveler transfers his/her booked reservation to a cancellation queue. The repurposing system enables a second user registered with the platform to input predetermined search criteria and book a new air travel inventory that includes at least one associated new air travel reservation.

### CROSS REFERENCE TO RELATED APPLICATIONS

The present application is a continuation-in-part (“CIP”) of U.S. Ser. No. 16/431,820 filed Jun. 5, 2019, which is based upon U.S. Ser. No. 62/680,686 filed Jun. 5, 2018, both hereby incorporated by reference for purposes of priority pursuant to Title 35, USC § 120.

### FIELD

The present subject matter is directed, in general, to air travel inventory and, more particularly, to a process and system for repurposing non-transferable air travel inventory.

### BACKGROUND

US published application 2019/0318276 to Rouveure discloses a system including a server that maintains data structures corresponding to a booking list and an ordered standby list. The booking list and the standby list have entries identifying at least one participant or item. The server receives input identifying a booking entry in the booking list to be canceled and, in response to receiving the input identifying the booking entry to be canceled in the booking list, removes a top entry from an ordered standby list and substitutes the canceled booking entry with the top entry removed from the standby list.

US published application 2019/0236852 to Ito et al. discloses a program for use in an electronic ticket system. An electronic ticket may be an electronic designated-seat ticket to which the designated seat is linked; and information of the designated seat may be displayed on an electronic ticket face, displayed on a display means after the electronic ticket is deleted, so as to be visually recognizable compared to the electronic ticket face displayed on the display means before the electronic ticket is deleted. A user terminal may include receiving means for receiving an instruction from outside the system to change the electronic ticket face. The face of the electronic ticket to be displayed on the display means may be changed upon condition the user terminal receives the instruction.

US published application 2008/0162196 to Espinosa et al. is directed to a process and system for identifying and consolidating information related to unused airline tickets. Such information is retrieved from a global distribution system (GDS) and is consolidated in a database of an air traveler booking agent, giving the booking agent automatic access to the information when there is an option to exchange an unused ticket for a new ticket.

Travelers may book travel services with several service providers. For example, a traveler may select and book transportation to an airport with a ground services provider; may select and book air travel with an air services provider; may select and book lodging with an accommodation services provider; may select and book sightseeing events with a sightseeing services provider; and may select and book restaurants with a food services provider. However, even when using systems designed to allow a traveler to select and book multiple service provider events simultaneously, conflicts between separately booked services may pose problems to travelers. U.S. Pat. No. 11,668,575 to Reis et al. discloses a system and a method for managing a travel itinerary by determining potential pre-event triggering events, then work with travel service providers to coordinate travel services selected and booked by the traveler. Also disclosed is a travel management system that receives from a traveler an electronic itinerary that specifies a plurality of events. Based on the electronic itinerary, the travel management system analyzes each of the plural events and then determines pre-event triggers for each of the plural events. Data analysis by the travel management system calculates trigger times associated with the pre-event triggers. The travel management system transmits, at the trigger times, the pre-event triggers to event managers, to execute a function corresponding to each event.

An airline is a company providing air transport services for traveling passengers and/or freight. Airlines use aircraft to supply these services and may form partnerships or alliances with other airlines for codeshare agreements, in which both offer and operate the same flight. Generally, airline companies are recognized with an air operating certificate or license issued by a governmental aviation body. Airlines may schedule or charter operators. A codeshare agreement, also known as a codeshare, is a business arrangement, common in the aviation industry, in which two or more airlines publish and market the same flight under their own airline designation including a flight number (an “airline flight code”) as part of a published timetable or schedule. Typically, a flight is operated by one airline (technically called an “administrating carrier” or “operating carrier”) while seats are sold for a flight by all cooperating airlines using their own designation and flight number. The term “code” refers to the identifier used in a flight schedule, generally a two-character IATA (International Air Transport Association) airline designator code and flight number. Thus, XX224 (flight number 224 operated by airline XX), might also be sold by airline YY as YY568 and by ZZ as ZZ9876. Airlines YY and ZZ are in this case called “marketing airlines” (sometimes abbreviated MKT CXR for “marketing carrier”). Most of the major airlines today have code sharing partnerships with the other airlines. Also, code sharing is a key feature of the major airline alliances. Typically, code-sharing agreements are also part of the commercial agreements between airlines in the same airline alliances.

Airline reservation systems (“ARS”) are systems that allow an airline to sell their inventory which includes seat reservations. For instance, an air travel reservation offered by a single air travel carrier from Cleveland, Ohio to New Orleans, Louisiana may result in a flight from Cleveland to Chicago, Midway Field, for the first leg of the flight, and then from Midway to New Orleans for the second, and final, leg of the flight. (Flight itineraries detail airports and times involved.) Air travelers owning smartphones and following an air carrier's pre-boarding procedure can, moreover, convert the reservation into an electronic boarding pass for both legs. Otherwise, air travelers normally receive paper boarding passes (also called tickets) bearing the air traveler's name and travel information for that carrier for both flight legs of an outbound flight from Cleveland's airport. For many air travel carriers, boarding passes entitle air travelers to occupy assigned airplane seats. Certain other air carriers, e.g., Southwest airlines, have an “open seating” policy requiring ticketed passengers to assemble in an orderly fashion to board the airplane and, once aboard, entitles ticketed passengers to select any unoccupied seat. Boarding passes, therefore, represent a non-transferable right to occupy an airplane seat for a limited time.

Accordingly, the term “air travel inventory,” throughout this patent specification, shall be understood as meaning one or more air travel reservations for a specified person.

Airline reservation systems (“ARS”) contain information on schedules and fares. ARS contain a database of reservations (or passenger name records) and issued tickets. ARS, part of passenger service systems (“PSS”), are applications supporting direct contact with passengers. ARS eventually evolved into computer reservation systems (“CRS”). A computer reservation system, used for the reservations of a particular airline, interfaces with a global distribution system (“GDS”) which supports travel agencies and other distribution channels in making reservations for most major airlines in a single system. A global distribution system (“GDS”) is a computerized network system owned or operated by a company that enables business transactions between a plurality of travel industry service providers, mainly airlines, hotels, and car rental agencies, including travel agencies. A GDS mainly uses real-time inventory (e.g., number of hotel rooms available, number of flight seats available, or number of cars available) from such service providers.

In the airline industry, available seats are thus commonly referred to as “inventory” and seating may be assigned or may be “open” (meaning unassigned). Inventory of an airline is generally classified into service classes (e.g., economy, premium economy, first class, business) including fare classes, for which pricing and booking conditions may apply. Fare classes, often noted by a single letter code, are complex and generally vary from airline to airline. The meaning of such codes, often unknown by most passengers, are designed to convey certain information to airline staff. For instance, these codes may indicate that a ticket has been fully paid for, or was discounted or purchased through a loyalty scheme, and so forth. Further in this regard, a predetermined number of seats may not be available for open sale but might be reserved, for example, for connecting flight passengers or loyalty-scheme passengers. Overbooking—a common airline practice—is an exception to inventory management. A core principle of inventory management is precision inventory control which is designed to keep a preselected number of seats available for different fare classes, by opening and closing individual fare classes for sale.

Thus, non-transferable inventory (i.e., inventory which cannot be transferred to a different person once sold), like air travel inventory provided by airlines and issued as tickets, is a consumer problem, given the risks and uncertainties life brings during days leading up to an event. Air travelers unable to use their tickets to take a flight face the risk of losing all their investment if their tickets are subject to non-refundable policies or such restrictions. The rise of more strict airline policies and restrictions applied across different ticket categories continue to offer less flexibility for air travelers, resulting in an increase in non-refundable tickets and air travelers unable to obtain monetary refunds for unused air travel reservations. The few tickets with relatively less restrictions may be canceled in exchange for air credit, but these still face limitations, such as being valid exclusively with the same airline for a specified length of time (e.g., within one year). Air travelers who do not use air credit received for unused tickets within time periods, as listed in the airline's policies, risk losing such air credit without receiving an alternative form of compensation.

Aviation law forbids the transfer of air travel tickets to another person after a ticket is purchased. In most situations, the purchase of airline tickets subjects the purchaser to restrictions designed to deprive the purchaser from receiving refunds for unused airline tickets. Although select unused tickets may have predetermined residual value qualifying as a voucher and serving as an “air credit” these, too, are subject to airline restrictions (such as restricting flights to original carriers) and limitations (such as limiting to one year).

Thus, air travelers or their travel services must be vigilant booking future flights, so that air credits are applied to such future flights whenever possible. If details associated with air credits cannot be recalled, a booking agent may need to access an appropriate global distribution system (GDS) for records of one or more tickets associated with the air credits. Even if the identifying information is available, accessing those records from an appropriate GDS can be tedious and time consuming. Also, even if records are located, the rules and restrictions for unused tickets must be properly analyzed to determine the residual value of the tickets and whether that residual value can be applied to a new ticket.

Consequently, when an air traveler needs to make certain changes to a purchased airlines ticket and also may need to make changes to an associated air travel itinerary, making such changes can be arduous. For instance, if a client phones to make changes to a purchased ticket, specifies the ticket, and acknowledges the policies and restrictions associated with the ticket, the client must also produce air credits for previously unused tickets. In addition, the client must determine current value of the credit, if still valid, which may take 30-60 minutes—or even longer if a call is “dropped.” Such an amount of time is typically unreasonable for a client to spend on a call booking a flight whenever time is critical. This situation also assumes air travelers can easily get unused ticket information.

Often, when a travel service (or other booking services or individual) purchases an airline ticket for an airline customer, the associated air travel booking service makes the arrangement through one of several global distribution systems. Traditionally, a GDS is a service, implemented through a computer system specific to an airline. Such computer systems were used to issue tickets to their customers. Current GDS are no longer airline specific and may be used to book tickets through any one of several well-known airlines.

Throughout the commercial airline industry, tickets are typically distributed through Global Distribution Systems (GDS), sometimes also known as Computer Reservation Systems (CRS). These include large, computerized reservation and ticketing systems such as Worldspan, Sabre, Galileo, and others. Until recently, air travel itineraries could only be booked through a travel agent with access to a GDS or with an air carrier directly through the air carrier's direct host ticketing environment. Commerce over the Internet has greatly affected the way in which airline ticketing takes place. Today there are many internet-based travel sites through which individuals can search for fares, book itineraries, and purchase tickets from their own personal computer (PC), without ever speaking to or visiting a travel agent. However, while such “online travel agencies” provide reservation booking and ticketing services in a somewhat more convenient manner, they still rely on current Global Distribution Systems to locate itineraries, calculate fares, and book tickets.

U.S. Pat. No. 7,769,610 to Liew et al. discloses a system and method for booking an itinerary on at least one of a plurality of host environments including a plurality of host adaptor modules. Each host adaptor module is configured to interact with other ones of the plural adaptor modules. A booking engine is provided to receive commands related to booking a desired air travel reservation and determining an appropriate host ticketing environment for processing associated commands based upon predefined criteria. Upon receiving a command, the booking engine forwards the command to a first host adaptor module associated with a first host ticketing environment which is selected by the booking engine to process the command. The host adaptor module receives the command and issues another command to the first host ticketing environment. The first host adaptor module, in turn, receives a response from the first ticketing environment and determines whether the response comports with an expected response. If the response does not comport with the expected response, the booking engine identifies a second appropriate host environment for processing the command and forwards the command to a second host adaptor module associated with the second host ticketing environment. The second host adaptor module then issues the command to the second host ticketing environment.

One feature of the present subject matter involves non-transferable inventory linked to ticketing. Another feature involves a process and system for booking tickets for air travel, in a situation where a booked air traveler ordinarily cannot transfer a ticket linked to an existing air travel reservation to another air traveler seeking to book a flight matching the flight associated with the ticket that the booked air traveler wants to transfer.

When booked air travelers must change or cancel an existing air travel reservation, they face limited options from airlines including restrictions and penalties, depending on type of fare purchased, often involving additional expenses including cancellation fees. This problem is particularly acute for the “non-refundable” travel ticketing fare category, where air travel customers, who choose not to pay high fees to change or cancel existing air travel reservations, do not receive a refund or reimbursement for their unused tickets.

Currently, a refund or reimbursement for unused tickets is only available when an air traveler purchases a costly refundable ticket or may occasionally be available when extraordinary circumstances are presented such as a health issue or death in the family. An air travel form of “trip” insurance, not always available as an option, if available, may include limitations, and must be purchased at the time of booking. Business meetings may take more time than anticipated, or other business opportunities may become known.

However, all current business models for changing or canceling non-transferable air travel inventory linked to booked air travel reservations (i.e., air flight tickets bought for a named person) only benefit the airline industry and penalize air travel customers when customers cannot make their flights. When requesting a change of date or time of departure, fees charged for such changes may surpass the cost of the original booking. Therefore, air travelers usually do not try to recover expenses involving canceled ticket purchases. Often, travelers miss a flight without notifying an airline, leading to an unused air travel reservation, where a booking air traveler might have purchased that reservation. This is also a missed business opportunity for airlines seeking to manage inventory more efficiently and more profitably while offering its customers a more satisfactory experience.

To date, there has been no effective solution to the problem of monitoring and exchanging unused, non-refundable tickets. Given the foregoing, there is a great need for a system and/or process that identifies, monitors, and provides timely and seamless access to data involving unused air travel tickets, so air travel customers and their agents can repurpose air travel reservations. Most air travelers would like available a system and method that enables them to change or cancel a currently non-transferable booked air travel reservation. The present subject matter provides a solution to this problem. Air travelers seeking to change or cancel their air travel reservations would favor options enabling them to repurpose an air travel reservation by finding another air traveler seeking a ticket with the same itinerary. Further appreciated, it would be desirable for the airline industry to “opt into” such a scheme, as it would manage inventory more efficiently, lead to an increased airline industry reporting linked to “percentage of seats occupied,” create new revenue streams, and increase air traveler and airline customer satisfaction.

### SUMMARY

One aspect or feature of the present subject matter, is directed to a process and system for repurposing an air travel reservation and its corresponding air travel itinerary.

The process and system each include a plurality of computers. Each of the plural computers includes, and is operatively connected to, at least one user interface. Each computer also includes a program product which comprises a machine-readable program code for causing, when executed, each computer to perform a series of programmed process steps. All, or a portion, of the programmed process steps may be predetermined or may be determined in real time, meaning “as the process steps are being performed.”

When operative, the process and system enable a first user to book a desired air travel reservation linked to a corresponding air travel itinerary. The process steps include accessing and querying a global distribution system (GDS) containing data associated with a plurality of air travel reservations. The process and system each include a digital platform adapted and configured to be accessed only by digital platform-registered users.

The process enables the digital platform, when operatively connected to the global distribution system, to access data associated with the plurality of air travel reservations.

The digital platform includes a cancellation queue containing one or more booked air travel reservations designated for cancellation by a booked air traveler—aka a first user.

A new ticket is generated where new air travel inventory is generated by the first user to repurpose an air travel reservation in the cancellation queue where the new inventory has the same itinerary, for purchase by a second user—the booking air traveler.

The process and system enable the second user to input search criteria for a desired air travel reservation and receive a new air travel reservation from the cancellation queue when a desired air travel reservation matches newly generated air travel inventory selected for cancellation. Thus, a non-transferable air travel reservation can be canceled.

Another aspect or feature of the present subject matter is directed to an improved process for issuing a first user (e.g., a booked air travel customer) of the system a full or partial refund for a canceled non-transferable reservation. For example, an air travel customer may want to change a booked reservation from Chicago, O'Hare airport to Cleveland, Ohio to one with a different port of departure. Since this booked reservation is non-refundable and the cost to change the reservation is high, the air travel customer might consider the option of repurposing this reservation to obtain a full or partial refund.

The improvement includes accessing a system including a plurality of computers. Each computer is operatively connected to at least one user interface. A digital platform is operatively connected to each of the plural computers. Digital platform registration by a user, including a first person or agent having at least one booked air travel reservation and a second person or agent seeking to book at least one air travel reservation, is a prerequisite to accessing the digital platform. The improved process includes accessing the digital platform to manage air travel inventory data which includes but is not limited to data associated with air travel reservations and associated itineraries which have been booked and are available for use by the booked air traveler or first user. The improved process includes inputting data associated with air travel customers registered with the digital platform who desire to book at least one air travel reservation and its associated itinerary. The improved process enables a booked air traveler (or first user) having purchased (and therefore having “booked”) one or more air travel reservations to select one of the booked reservations for transfer to a cancellation queue on the digital platform.

Yet another aspect or feature of the present subject matter enables a person to designate for repurposing one of the booked air travel reservations owned by or assigned to the person, enabling a booked air traveler to transfer a designated reservation to the cancellation queue on the digital platform. A new inventory with the same travel itinerary is generated when a digital platform-registered, booked air traveler transfers a booked reservation to the cancellation queue. The newly generated inventory can be matched to search criteria of another platform-registered, booked air traveler seeking to book air travel with the same itinerary. The reservation is only cancelled after the newly generated inventory has been purchased by another air traveler registered with the digital platform.

Another aspect or feature of the present subject matter includes receiving from a second user registered with the digital platform a search criterion for inventory the second user desires to book. The improved process includes querying the digital platform as to whether the desired itinerary of the booking air traveler matches a new travel inventory generated by at least one of the air travel reservations designated for repurposing and selected for transfer to the cancellation queue by the booked air traveler; and, when there is a match, the process enables the second user to purchase the new travel inventory.

After the second user purchases the new inventory, a new air travel reservation and its associated itinerary are designated in the digital platform for use by the registered booking air traveler (i.e., the second user) and the booked reservation designated by the first user (i.e., booked air traveler) for repurposing in the cancellation queue is canceled.

After the air travel reservation in the cancellation queue designated by the first user (i.e., the original booked air traveler) for repurposing has been canceled, the system and process of the present subject matter process includes issuing the first user a refund.

### BRIEF DESCRIPTION OF THE DRAWING FIGURES

FIG. 1, showing an embodiment of a procedure to search for an available air travel reservation, presents a portion of a process flow diagram for the present subject matter.

FIG. 2 presents a remainder portion of the process flow diagram shown in FIG. 1.

FIG. 3 is a flowchart depicting an embodiment of a request cancellation procedure.

FIG. 4 illustrates an embodiment of a systems interaction flowchart for FIGS. 1, 2.

FIG. 5 is a flowchart of another embodiment of the request cancellation procedure.

FIG. 6 is a flow chart showing operation of a system of the present subject matter when used by a first user, i.e., a person or agent looking to repurpose an air travel reservation which may potentially go unused and a second person, i.e., a person or agent looking to purchase either a new air travel boarding pass or a new air travel reservation.

FIG. 7 is an example of a digital platform system 200 of the present subject matter.

FIG. 8 is a schematic illustration of a conventional data storage-and-transmission system 300 which incorporates digital platform system 200 of the present subject matter.

Throughout the drawing figures and the detailed description, similar alphanumeric references shall be used to refer to features of the present subject matter that are similar.

### DETAILED DESCRIPTION

The following detailed description presents the currently contemplated “best mode” of carrying out the exemplary embodiments of the present subject matter. The following description, not presented in a limiting sense, is therefore made for purposes of illustrating the principles of the present subject matter with its scope defined by the appended claims.

Briefly stated, the following embodiments of the present subject matter are directed to currently contemplated “best mode” examples of a system and process for repurposing non-transferable air travel inventory including one or more booked air travel reservations.

Repurpose: The term “to repurpose” as used throughout this patent specification, pursuant to the present subject matter, shall be understood to mean: to amend, cancel, exchange, or use in a way different from originally scheduled, any previously purchased (booked) air travel inventory including at least one booked, non-transferable reservation.

The system and process each may include a digital platform, for which registration is required before use is permitted. The system and process each may also include a computer program product providing registered air travelers having newly generated air travel inventory an opportunity to be reimbursed for such inventory no longer needed by allowing them to repurpose their booked reservations, which enables them to match newly generated air travel inventory with other air travelers looking to book reservations.

In embodiments, a first person or agent registered with the digital platform and having one or more booked air travel reservations may select one or more of the booked air travel reservations for cancellation; and the one or more booked air travel reservations selected for cancellation may be transferred to a cancellation queue of the digital platform.

A person registered with the digital platform may seek to book air travel inventory including at least one air travel reservation. Another person registered with the digital platform may own air travel inventory including at least one booked air travel reservation that the owner seeks to repurpose, has transferred to a cancellation queue, resulting in a new air travel inventory being generated. The newly generated air travel inventory is designated as “pending-for-sale.” When an air travel reservation sought to be booked by a person or agent matches a newly generated air travel inventory, the booked reservation selected for cancellation and transferred to the cancellation queue may be canceled, and thereafter repurposed, after which a refund is processed and paid to the original owner.

In embodiments, a new air travel inventory is generated, to repurpose an air travel reservation in the cancellation queue and bought by a booking air traveler. In accordance with the present subject matter, after a payment for the pending reservation is received from the person or agent booking the pending reservation and a new air travel reservation issued to the person or agent booking the pending reservation, the pending reservation in the queue is next moved to a refund queue and a refund is “processed,” meaning that a financial procedure, between air travelers registered with the digital reservation system, to pay the prior owner for a previously booked, now “repurposed,” reservation is initiated.

When no payment is received from a booking air traveler by a predetermined time, the pending-for-sale identification is removed, while the new air travel inventory remains available to be purchased and the air travel reservation in the cancellation queue remains available to be repurposed until the door of the scheduled air travel reservation is “closed.”

For additional features and advantages of the present subject matter, an air travel reservation system designed, adapted, and configured for repurposing air travel inventory including at least one booked travel reservation shall be described in detail further below.

The reservation system includes a plurality of computers. Each of the plural computers has a user interface. The reservation system also includes a program product.

The air flight reservation system includes a machine-readable program code or application (“app”) for causing, when the app is executed, at least one of the computers to perform a series of process steps including presenting travel itineraries corresponding to one or more existing air travel reservations of a first user. A selection from the first user, specifying a designated reservation from one or more booked air travel itineraries, triggers a cancellation request. A booked travel reservation selected along with at least one associated itinerary designated is transferred to a cancellation queue to be repurposed. In embodiments, the first user may thereafter be notified of a full refund or a partial refund.

When a match between a booking air traveler and a booked air traveler is found, the booked air traveler who sought to repurpose at least one of his/her booked air travel reservations is entitled to compensation for releasing his/her reserved air travel inventory.

The digital platform of the present subject matter benefits air travelers with existing reservations seeking to be refunded for their unused tickets and/or reservations. Also benefitted are air travelers seeking to change travel plans, after making a reservation, by giving such air travelers options beyond standard airline options which may only include high change-of-flight fees, cancellation fees, or air-credit vouchers, usually only valid for one year, offering them an opportunity to be better compensated for unused reservations.

By creating a platform where air travelers repurpose existing reservations and be matched with air travelers seeking similar reservations, the platform offers flexibilities and provides travelers with more opportunities to find better solutions to their air travel needs.

Currently, air travelers who need to cancel reservations or change itineraries have no choice but to pay high charges and cancellation fees imposed by airlines, which could exceed the price of original reservations. As a result, many air travelers opt to not show up to their flights and must then purchase new tickets. While this model has been giving airlines a great advantage for decades, limited options offered by airlines do not benefit their customers and have been creating a negative impact on air travelers in many ways.

This model offers air travelers an alternative by giving them more control over their air travel reservations, allowing them to repurpose their reservations and provide them with an opportunity to get reimbursed. The digital platform benefits air travelers looking to change or cancel their existing reservations, as well as those looking for air travel offers with flexibility, if they learn they need to change travel plans after booking a reservation.

The digital platform of the present subject matter gives air travelers an alternative to options offered by airlines by giving them opportunities to repurpose their booked travel reservations by matching them with flight reservations or air travelers seeking similar travel offers. Instead of paying the airlines high fees and penalties, the model gives air travelers—who want to change or cancel a reservation—an opportunity to be reimbursed.

Registration: As a preliminary step, a prospective user must first register with the digital platform by creating a user account. After entering all his/her personal information required for the mode of travel (full legal name, address, passport details, and so forth), a registered user can thereafter use the digital platform to search the cancellation queue and a plurality of global distribution systems (GDS) operatively connected to the digital platform for finding a desired air flight via the GDS or digital platform. Such flights include non-transferable air travel reservations and their associated boarding passes (e.g., paper and electronic tickets). A registered air traveler with an air reservation can make any air travel reservation available to the digital platform for repurposing, so long as the ticket associated with the air travel reservation has not expired, been used, or been canceled.

In this example, a booked air traveler may desire to cancel or change a previously booked airline flight. For this example, the term “itinerary” shall be understood as meaning “a plan or outline for a planned journey or route.” Consider, e.g., an itinerary for a booked air flight between Charleston, S C, and Rochester, NY, with Atlanta, GA, as the in-between stop for this air travel reservation. While at the in-between stop, the booked traveler may decide to stay in Atlanta for one week longer than originally planned and thereafter return home. The air traveler, if registered with the digital platform, may decide to repurpose his/her unused air-flight leg before a flight associated with the booked reservation departs.

In embodiments of the digital platform of the present subject matter, the digital platform does not provide visibility or awareness (including identity or other personal information) of either the booking air traveler or the previously booked air traveler, or the air travel itineraries of either of the respective air travelers. Rather, all data input into the digital platform for “new-inventory-search” and “air travel reservation-booking paths,” is stored pursuant to a highly confidential protocol, and is segregated from all other data.

In operation, a user can use the digital platform in an assortment of ways, including to purchase a new flight reservation for future air travel, or to repurpose his/her existing reservation to be reimbursed (fully or partially) for the value of his/her unused reservation.

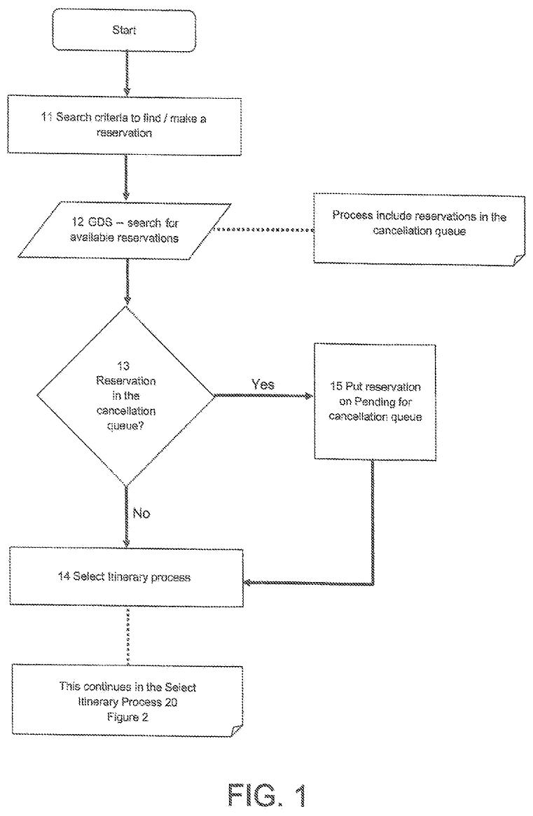

Please refer to FIG. 1 which shows an embodiment of a procedure to search for an available air travel reservation. FIG. 1 presents a portion of a process flow diagram, illustrative of the present subject matter. As shown in FIG. 1, a booking air traveler may enter one search criterion or several search criteria, at step 11 to input air travel data including but not limited to departure and arrival locations for making a travel reservation.

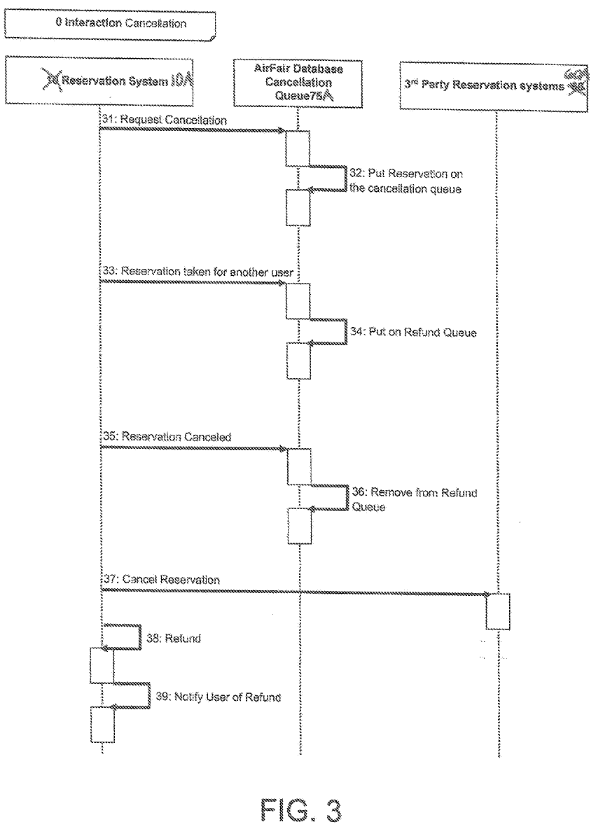

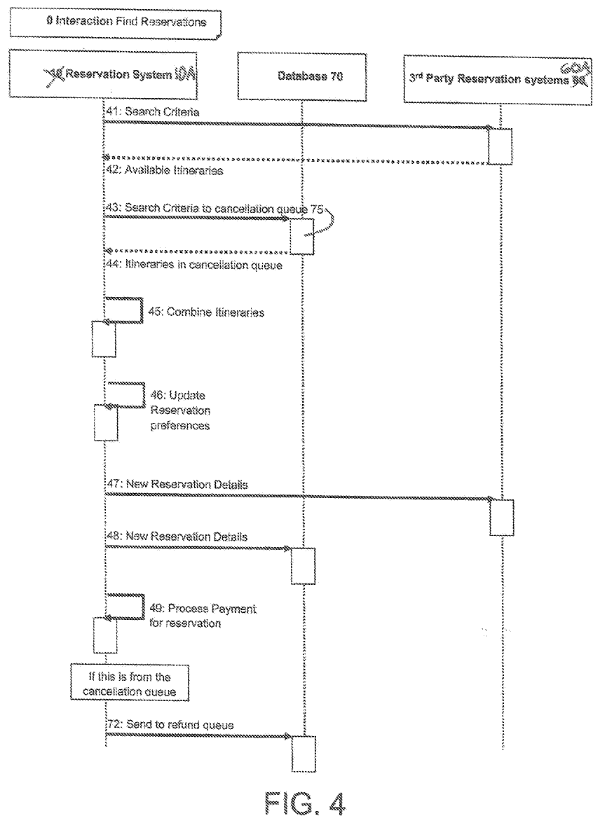

When purchasing an air travel reservation, a user will enter his/her search criteria, at step 11, to browse available travel options including flights and associated itineraries. The digital platform or reservation system 10 will access network database 70 (FIG. 4) to find available inventory from the 3^{rd} party partner reservation systems 60A (FIGS. 3-5) via global distribution systems (GDS) 60B operatively connected to the digital platform.

The digital platform enables a registered user to search for available inventory, and will present all meeting the user search criteria, at step 11, since search criteria is matched to newly generated air travel inventory. The user may select a preferred air flight inventory or look for more options by modifying an earlier input search criterion, step 11.

To search for available inventory, the system will receive the criteria from the user seeking to make a flight reservation and reference against a cancellation queue 75 (FIG. 4) of a cancellation process database. An inventory search portal may be configured similar to conventional travel search portals to access Global Distribution Systems (GDS).

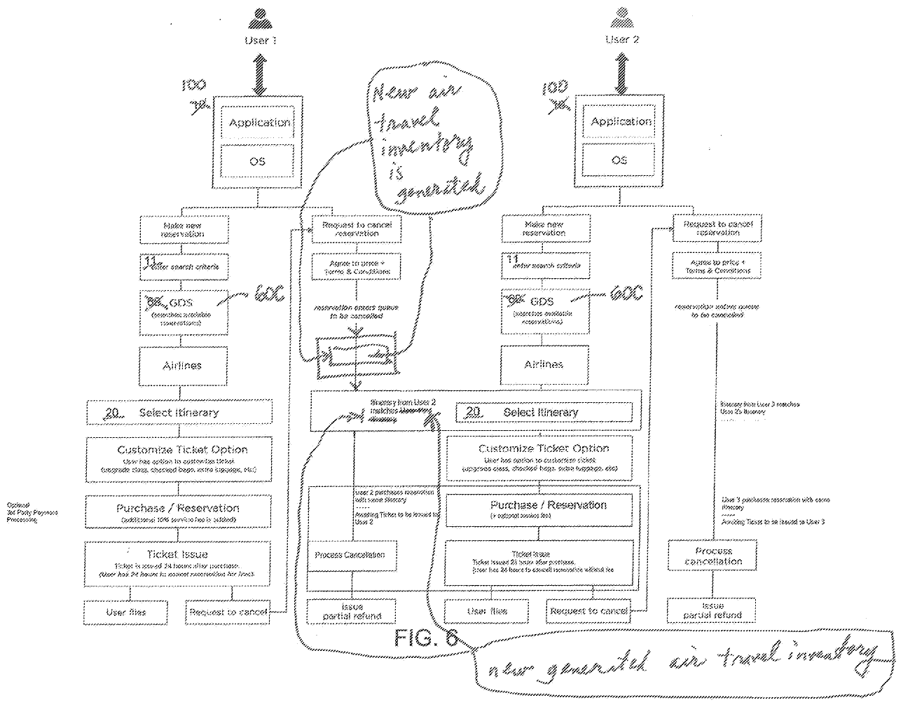

Entering search criteria to find available air travel inventory or purchase a desired reservation, step 11 (FIGS. 1 and 6), typically involves using a global distribution system (GDS) 60B (FIG. 6), step 12, to query or search for new air travel inventory generated to repurpose one or more air travel reservations in the cancellation queue (FIG. 1). At step 13, a query or search function asks whether a desired reservation matches a reservation in the new air travel inventory? If “Yes,” the matching air travel reservation is marked “pending-for-sale” in the cancellation queue. If “No,” step 14, of the process is selected.

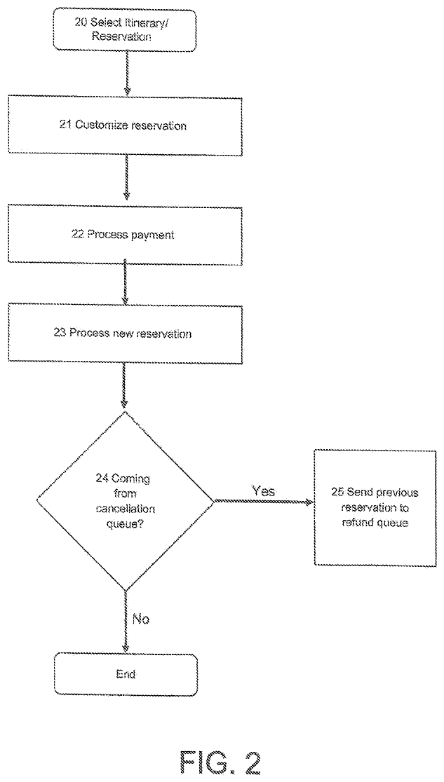

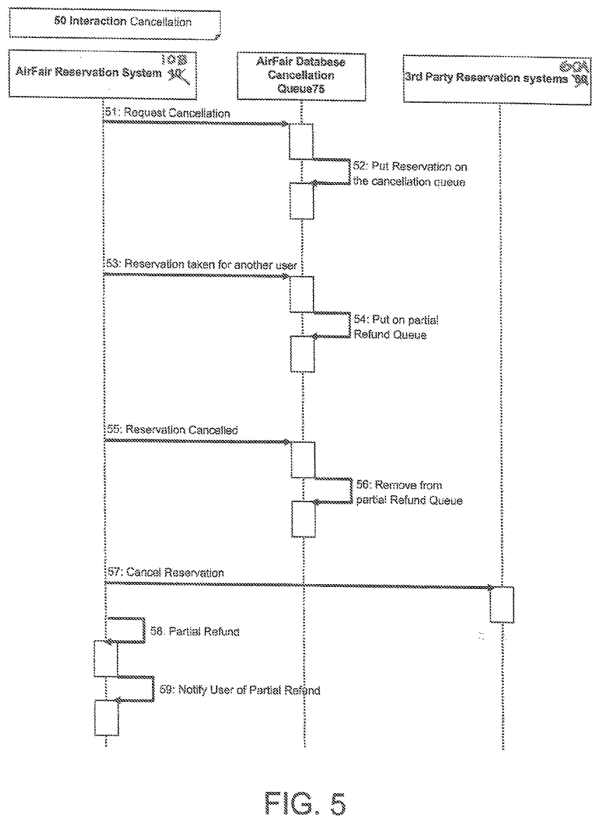

System 10 will look for available inventory in the GDS systems 60B (FIG. 6) as well as new air travel inventory generated to repurpose air travel reservations in the cancellation queue 75. (See FIG. 4.) See also box 50 (FIG. 5.) Searching inventory of booked air travelers registered with the digital platform and other inventory of booked air travelers supplied by plural global distribution system (GDS) sources (noted) proceeds to step 20, of FIG. 2. Inventory sought by a booking air traveler registered with the digital platform is customized, step 21. Payment for the customized inventory is processed, step 22. New air travel inventory, which may be issued to the booking traveler as one or more paper or electronic boarding passes, is/are issued to the booking traveler, step 23. Next, whether cancellation queue can provide the reservation is determined, step 24. If “No,” the inventory search ends. If “Yes,” the reservation is moved to a refund queue, step 25.

The system 10 will present available inventory results to enable the booking air traveler to select from any of the available inventory, including available inventory within the plural 3^{rd} party GDS systems 60A (FIGS. 3-5) and new air travel inventory generated to repurpose air travel reservations in the cancellation queue 75 (FIG. 4). Booking air travelers then select a desired air travel inventory from the available air travel inventories.

At step 13 (FIG. 1), if the booking air traveler registered with the digital platform selects inventory that does not match a new air travel inventory generated to repurpose air travel reservations in the cancellation queue 75, the system 10 will proceed to the “select itinerary” procedure, step 14. If the inventory selected by the booking air traveler corresponds to the repurposed air travel reservation now in the cancellation queue 75, step 15, the system 10 tags the repurposed air travel reservation in the cancellation queue 75 as a reservation “pending-for-sale” to initiate a cancellation procedure (FIG. 3).

As shown FIG. 2, the system takes the booking air traveler to the select inventory procedure, step 20. At step 21, the booking air traveler can customize the selected inventory, based on his/her needs. Potential aspects include, but are not limited to, selecting and/or changing a seat, assigning a passenger name to a seat, pre-checking baggage, and may include inputting data relating to date-of-birth, nationality, primary residence, dietary restrictions including preferred meals, etc. After the booking air traveler has customized the selected inventory, system 10 then proceeds to payment, step 22.

At step 22, the booking air traveler purchases the selected inventory, at which time it becomes a new air travel reservation. At step 23, the new air travel reservation could be issued to the booking air traveler as either a paper ticket or an electronic (paperless) ticket. At step 24, the system determines if the new air travel reservation matches a new air travel inventory generated to repurpose an air travel reservation in the cancellation queue 75 (FIG. 5). If the response is “YES,” the status of the tagged itinerary is promoted to “pending refund” status in cancellation queue 75. System 10 may then initiate a partial or full refund to the booked air traveler for the air travel reservation in cancellation queue 75. In embodiments, it may be desirable to pause the “pending refund” process by a predetermined amount of time. To provide a non-limiting example, a predetermined amount of time may be a grace period during which the booking air traveler may cancel the new air travel reservation without incurring a penalty. In embodiments, the grace period could end 24 hours after the air traveler purchased the new air travel reservation.

A “request cancellation” procedure allows an air travel reservation to be used to generate new air travel inventory and make the new air travel inventory available to reservation system 10. (FIG. 3) As a result, a booked air traveler may select an air travel reservation to be repurposed. System 10 prompts the booked air traveler to review and agree to a listed price including terms and conditions. After a request to cancel a booked reservation is selected, step 31, a repurposing selection, from reservations of the booked traveler is transferred into Cancellation Queue 75A, step 32. Reservation system 10 is adapted and configured to allow a booked traveler to recover a previously booked reservation selected for repurposing, now in cancellation queue 75, if a reservation selected for repurposing has not expired, been used, or canceled. If the new travel inventory matches a booking air traveler's search, the booking air traveler can select the new air travel inventory for purchase. If the booking air traveler purchases the new air travel inventory, a new air travel reservation is issued to the booking air traveler, and the air travel reservation in cancellation queue 75 is transferred to a “refund queue,” step 34 (FIG. 3). If the booking air traveler fails to purchase the new air travel inventory within a predetermined period or, after purchasing, cancels the new air travel reservation within a predetermined period after the purchase date, a “pending-for-sale” tag in cancellation queue 75 is removed, the new air travel inventory is made available for purchase, and the air travel reservation in cancellation queue 75 is again made available for repurposing.

After a booking traveler purchases new air travel inventory generated to repurpose an air travel reservation from air travel inventory of a registered digital platform user in the cancellation queue 75, the booked air traveler may be issued a full or partial refund, step 38. The reservation system 10 may also send a notification of such reimbursement, step 39. When the temporal period occurs, the refund, step 38, and the notification, step 39, are executed and the original air travel reservation is canceled, step 37. The 3^{rd} party partner reservation system 60A (FIGS. 3-5) is notified of the cancellation to prevent the original booked air traveler from making use of the now canceled air travel reservation.

To fetch and use information about reservations in the 3^{rd} party partner reservation system 60A, the reservation system 10 must interact with the 3^{rd} party partner reservation system 60A and a database 70. An interaction diagram, FIG. 4, illustrates procedures outlined in FIGS. 1 & 2 in terms of the interaction between system 60A and database 70.

At step 41, search criteria (step 11, FIG. 1) are presented to a 3^{rd} party partner reservation system 60A to find available inventory across supported airlines. At step 42, 3^{rd} party reservation system 60A returns available inventory based on search criteria of a booking traveler. At step 43, the search criteria are sent to cancellation queue 75 to find new air travel inventory generated to repurpose air travel reservations selected for repurposing (“pending-for-sale” in cancellation queue). At step 44, cancellation queue 75 outputs new air travel inventory generated to repurpose air travel reservations in the cancellation queue matching the search criteria. Inventory matching the search criteria from 3^{rd} party reservation system 60A and cancellation queue 75 are combined, step 45. At step 46, reservation preferences are updated. At steps 47 and 48, new reservation details are output for transfer to the 3^{rd} party reservation system 60A and database 70.

At step 49, if a second user purchases new air travel inventory generated to repurpose an air travel reservation in the cancellation queue 75, funds for that air travel reservation will be sent to a refund queue, step 72 (FIG. 4), where there may be a predetermined amount of time before the original air travel reservation is canceled and a refund is issued to the booked air traveler. Cancellation interactions 50 are illustrated in FIG. 5. The booked air traveler selects an air travel reservation to repurpose. Reservation system 10 transfers, at step 51, the repurposed air travel reservation to the Database Cancellation Queue 75A, after which the repurposed air travel reservation is identified as “pending-for-sale,” step 52. At step 53, when a booking air traveler registered with the digital platform purchases a new ticket that matches a new air travel inventory generated to repurpose an air travel reservation in the cancellation queue, the air travel reservation in the cancellation queue is promoted to the refund queue (step 72, FIG. 4), where it is “paused” for the predetermined amount of time, for example, for a 24-hour waiting period.

After the predetermined amount of time has occurred, the air travel reservation is canceled, at step 55, is deleted from the refund queue, at step 56, and is canceled from the 3^{rd} party reservation system 60A, at step 57. At step 58, Air Fair reservation system 10 issues a refund, full or partial, to the booked air traveler. At step 59, a notification is automatically dispatched to the booked air traveler after the refund has been processed.

The digital platform of the present subject matter must be able to access at least one of a plurality of global distribution systems (GDS) or at least one other data repository to gain information about air travel inventory from partner airlines. Information involving new air travel inventory generated to repurpose air travel reservations in the cancellation queue also must be accessible for obtaining data involving air travel inventory including associated itineraries and other information required from registered booked air travelers, since it may be necessary to review air travel reservations and other relevant information on existing reservations, including making any necessary changes to these reservations.

To generate a registered user database 70, each user must compose a profile with username password, personal details (full legal name, passport details), and preferred mode of travel (e.g., economy, business, or first class). Such user information will be used along with search criteria by registered users seeking reservations via the digital platform.

Accordingly, the digital platform of the present subject matter may utilize one or more payment (e.g., bank, credit card, line-of-credit) systems including one or more reservation systems “linked to” (i.e., operatively connected to) air travel systems, each with associated security systems, allowing users to use chosen methods of payment. The digital platform may advantageously be configured to accept other payment options, including using a traveler's existing air miles, when making a booking on a selected airline. The digital platform may also be configured to accept credit card so-called “incentive” points in exchange for travel booking, and/or options for crediting an account for a refund related to repurposing air travel reservations of a data base registered booked air traveler.

Referring to FIG. 6, embodiments of a digital platform 100—for each of user 1 and user 2—may include a mobile computing device, such as a smartphone (Android or iOS) with a functional network connection, e.g., cellular, LAN, or Wi-Fi connection, and have established an operable network connection to the internet. The mobile computing device may include an application for accessing and interacting with each digital platform 100. Each digital platform may connect with a predetermined application program interface (API) to access at least one of a plurality of global distribution systems (GDS) 60C to access air traveler and flight data (for available inventory). Each digital platform 100 displays data, where either user 1 or user 2 can select, cancel, or change an air travel reservation. Data input, transferred to an appropriate API and is archived in database 70.

The system of the present invention may include a plurality of computers. Each computer may include at least one user interface. Exemplary computers include but are not limited to laptop computers, desktop computers, so-called personal computers (PCs), and Apple computers. Additional exemplary computers include but are not limited to smart devices including but not limited to tablets and smart phones. Each computer may include a program product including but not limited to a machine-readable program code adapted and configured for causing, when executed, the computer to perform an assortment of predetermined steps. The program product therefore may include software which may either be loaded onto one of the computers described or accessed by such computer. Also, loaded software may include an application on a smart device. Software may be accessed by such computers using a web browser. The computers may access software via a web browser using the internet, an extranet, intranet, host server, or “internet cloud.”

The computer-based data processing system and method—described above—is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may operate or be run on a stand-alone computer system or may operate or be run from a server system accessed by a plurality of client computer systems interconnected over an intranet network, or accessible over the Internet. In addition, many embodiments of the present invention have application to a wide range of industries. To an extent, the present application discloses a system, the method implemented by that system, as well as software stored on a computer-readable medium and executed as a computer program to perform the method on a general purpose or special purpose computer, are within the scope of the present invention. Furthermore, to an extent the present application discloses a method, a system of apparatuses configured to implement the method are within the scope of the present invention. It is understood, of course, that the foregoing relates to exemplary embodiments and that modifications may be made without departing from the spirit and scope of the present invention as set forth in claims.

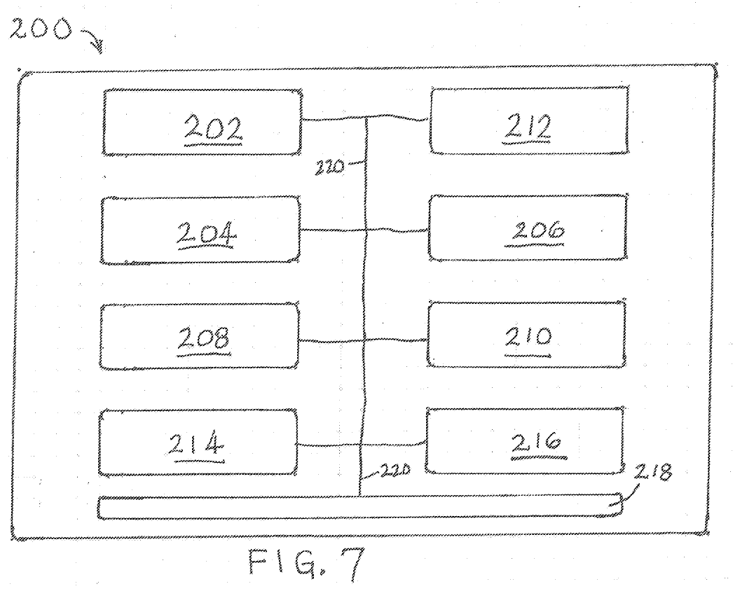

FIG. 7 presents an example of a digital platform system 200 of the present subject matter. The digital platform system 200 includes communication receiving provisions 202, a digital platform user registration component 204, and electronic locking provisions 206.

Digital platform system 200 also includes a memory or data storage component 208, cancellation queue provisions 210, and communication transmitting provisions 212.

The digital platform system 200 of the present subject matter includes a controller component 214, a processor component 216, and a power source 218. Digital platform system 200 also includes a power-distribution and data-transmission harness 220 which is adapted and configured for providing and distributing power to the communication receiving provisions 202, the digital platform user registration component 204, the electronic locking provisions 206, the memory or data storage component 208, the cancellation queue provisions 210, the communication transmitting provisions 212, the controller component 214, and the processor component 216. The harness 220 is also adapted and configured, when the system 200 is used by a person registered with the digital platform system 200, for enabling data to be transmitted from, between, and amongst each of the communication receiving provisions 202, the digital platform user registration component 204, the electronic locking provisions 206, the memory or data storage component 208, the cancellation queue provisions 210, the communication transmitting provisions 212, controller component 214, and processor component 216.

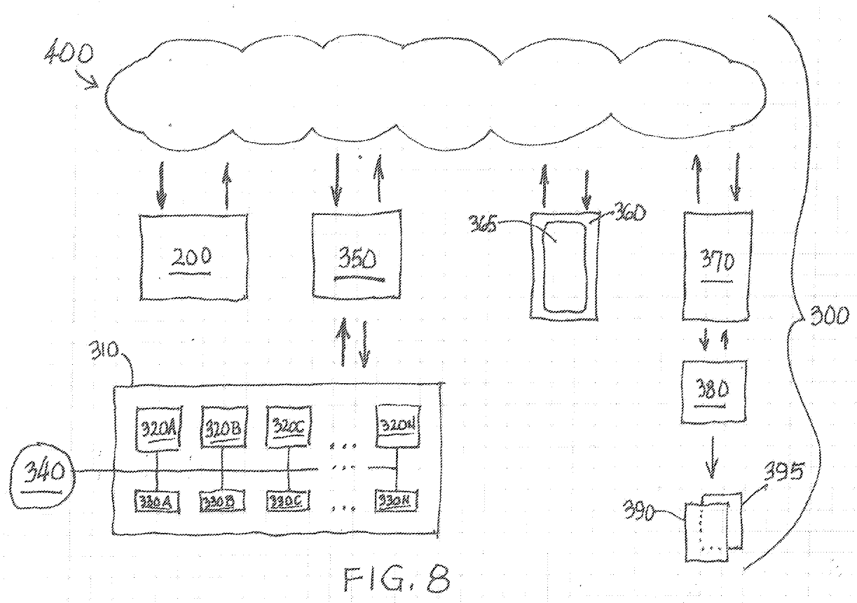

FIG. 8 is a schematic illustration of a conventional data storage-and-transmission system 300 which incorporates digital platform system 200 of the present subject matter.

The data storage-and-transmission system 300 includes data-input provisions 310 which include a plurality of computers 320A, 320B, 320C, . . . and 320N and an associated plurality of user interfaces 330A, 330B, 330C, . . . and 330N, each of which is operably connected to an associated one of the plural computers 320A, 320B, 320C, . . . and 320N.

A power source 340 provides power to each computer and to each user interface.

The data storage-and-transmission system 300 shown in FIG. 8 also includes the digital platform system 200, at least one global distribution system (GDS) 350 operably connected to a plurality of airlines, an electronic device 360—such as, iPad (Apple), iPhone (Apple), or another smart phone (Samsung, Asus, Gionee, Google Pixel, etc.)—with a screen 365 configured to display a new air-flight reservation including one or more associated boarding passes. System 300 includes another electronic device 370 operably connected to a printer 380 equipped and configured to print a new air-flight reservation 390 including one or more associated boarding passes 395 on aptly sized sheets of paper.

The data storage-and-transmission system 300 shown in FIG. 8 further includes a cloud-based infrastructure 400 adapted and configured for providing data transmission and communication between the cloud-based infrastructure 400 and each of the GDS 350, including each of the electronic devices 360 and 370, and when the digital platform system 200 is accessed by a person registered with the digital platform system 200, information stored in memory component 208 or in the cancellation queue provisions 210.

Digital Platform System 200. The registration component 204 receives information and data from users registered with the system 200. The memory or data storage component 208 retains air traveler information including booked airline reservations and associated itineraries. The cancellation queue provisions 206 include database of one or more cancellation queues. Registered users may select one or more airline reservations from the data storage component 208 for transfer to at least one of the cancellation queues. Electronic locking provisions 206 govern access to information in the memory or data storage component 208 or transferred into any of the one or more cancellation queues. The registration component 204 in many embodiments of the present subject matter is provided with one or more computer servers or units that are remotely located. As described herein, registration component 204 is typically accessed via the world wide web (i.e., internet) and is designed, adapted, and configured to make use of conventional cloud-based data storage, data analysis and processing, including data transfer channels. The registration component 204 includes a database and/or data storage provisions in which user information is retained. Nonlimiting examples of such information include customer or user name; registrant name if different from customer or user name; company or organization name; contact information of user, registrant, and/or company; date of initial registration of customer or user; dates of logins; dates of subsequent registrations, if any; password(s) and other confidential information relating to a customer or user, registrant, and/or company; corporate status, if any, of each customer or user (e.g., CEO of ABC Corp.; COO of LMN Corp; Chief Financial Officer of XYZ Corp; etc.). The registration component 204 may include communication provisions so that the registration component 204 can exchange, transmit, and/or receive information or data from one or more electronic devices 360, 370. In many embodiments of the present subject matter, registration component 204 includes internet communication provisions. Systems disclosed herein, particularly registration component 204, use cloud-based data storage and/or cloud-based data analysis and processing and thus can be accessed and implemented in a distributed fashion using remotely located servers or other computers.

Typically such servers, computers, and other devices are accessed via the internet. Cloud-based storage and data analysis and processing means include online storage or processing by which data is virtually stored or analyzed and processed across one server or multiple interconnected servers, typically hosted by plural service providers.

The term “cloud-based computing” system throughout this patent specification shall be understood to include one or more of cloud-based data storage units, one or more cloud-based data analysis and processing units, and one or more cloud-based data transfer units. Associated service providers may include one or more data center artificial intelligence (“AI”) units adapted and configured, or experienced human operators trained, to provide resources based on expressed customer necessities and other requirements.

Embodiments include a method comprising selecting a set of one or more cloud service providers to perform a data processing job based on information about the set of one or more cloud service providers and criteria of the data processing job. A plan for a cloud pipeline for performing the data processing job is designed based, at least in part, on the information about the set of one or more cloud service providers. The plan comprises a set of one or more processing stages each of which indicates processing upon a subset of a data set of the data processing job. Allocated resources of the set of one or more cloud service providers are mapped to the set of processing stages. Instructions and software images based, at least in part, on the plan are generated. The instructions and the software images implement the cloud pipeline for performing the data processing job. The instructions and the software images are transmitted to machines of the set of one or more cloud service providers. The allocated resources comprise the machines. The machines including the performance of the data processing job are monitored. If monitoring detects a failure, then the cloud pipeline is adapted to the failure.

Embodiments also include a computer program product for establishing a cloud pipeline for a data processing job. The computer program product comprises a computer readable storage medium having computer readable program code embodied therewith. The computer readable program code comprises computer readable program code. The computer readable program code is configured to design a plan for a cloud pipeline for performing the data processing job based, at least in part, on cloud service provider data about a set of one or more cloud service providers. The plan comprises a set of one or more processing stages, each of which indicates processing upon a subset of a data set of the data processing job. Computer readable program code is also configured to map allocated resources of the set of one or more cloud service providers to the plurality of processing stages. Computer readable program code is configured to generate instructions and software images based, at least in part, on the plan. The instructions and the software images implement the cloud pipeline for performing the data processing job. Computer readable program code is configured to transmit the instructions and the software images to machines of the set of one or more cloud service providers. The allocated resources comprise the machines. Computer readable program code is configured to monitor machines and data processing jobs. Computer readable program code is configured to adapt the cloud pipeline to a failure if computer readable program code configured to monitor the machines and the data processing job detects a failure.

The storage services may be accessed via web service application programming interfaces (API) or via web-based user interfaces (UI). In addition, cloud-based computing is described, e.g., in U.S. Pat. No. 11,650,859 to Shil; U.S. Pat. No. 10,067,798 to Netto et al.; U.S. Pat. No. 9,871,857 to Russinovich et al.; U.S. Pat. No. 8,966,251 to Gu; and U.S. Pat. No. 8,607,242 to Clarke—each of which is hereby incorporated by reference in its entirety.

Mobile Electronic Devices. The present subject matter is also used in combination with mobile electronic devices. Mobile devices can take various forms such as smartphones, tablet computers, or laptop computers. More particularly, the mobile device includes a computing device that may be a small, portable electronic device, e.g., a mobile phone or smartphone, or, alternatively, a personal data assistant (PDA), a personal media player device, an application specific device such as a tablet or slate computing device, or a hybrid device that may include any of the above functions. Nonlimiting examples of smartphones include devices running on Android or iPhone, e.g., iOS, platforms. Nonlimiting examples of tablet computing devices are IPADs available from Apple Corp.

Mobile devices may also be in the form of a personal computer including both laptop computer and non-laptop, e.g., desktop, computer configurations. The mobile devices include electronic data storage provisions, control provisions, communication provisions, and user interface provisions. The data storage provisions of mobile devices enable information relating to air travel customer or user information, including user-access, data-transfer, cancellation-queue review and/or analysis data permissions relating to user registration. The data storage provisions, in addition to disclosure set forth above, include a form of known data storage formats such as flash memory components.

The data storage provisions may also include or be in the form of memory cards, disk or drive components, data cartridges or components such as ROM or RAM memory, and peripheral data storage components. The control provisions of the mobile devices typically include electronic circuitry that is generally in the form of one or more processors.

The mobile devices also include communication provisions between the mobile device and one or more servers and between the mobile device and the registration and control component. Communication between the mobile device and a server can be established (or provided) by using one or more communication formats including radio frequency (RF), infrared (IR), and/or BLUETOOTH, as known in the art. In embodiments, communication is by a wireless local area network (WLAN), i.e., Wi-Fi. Mobile devices may be communicatively coupled to cloud-based service and data centers including a third-party entity via, e.g., at least a wireless local area network technology (WLAN), i.e., Wi-Fi. However, embodiments of local access to cloud-based storage are not limited to wireless communications, and therefore hard-wired communications may also apply to the embodiments described herein. The mobile devices also include communication provisions between mobile devices and registration components and control components.

Such internet communications typically make use of cloud-based infrastructure. Advantageously, the present subject matter includes the use of other communications between mobile devices and the registration and controller components. As previously noted, mobile devices include electronic data storage provisions and control provisions. In many embodiments of the present subject matter, the mobile device is configured to run or execute an algorithm or “app” as known in the art which facilitates communication with registration component and/or the controller component of the present subject matter. Software involving such algorithms (or “apps”) including their transfer and/or download features, including the running and maintenance thereof are described, e.g., in U.S. Pat. No. 8,549,656 to Blaisdell et al.; U.S. Pat. No. 8,875,298 to Li et al.; U.S. Pat. No. 9,043,480 to Barton et al.; U.S. Pat. No. 9,100,390 to Asnis et al.; U.S. Pat. No. 9,135,418 to Wade et al.; and U.S. Pat. No. 9,246,893 to Boyer et al., each of which is hereby incorporated by reference in its entirety. Algorithms or apps may facilitate administration of permissions from the registration component including the controller component, the transmission of data or information between the registration and control components, and mobile devices.

### Improved Process for Issuing Refund to Booked Air Traveler

Another aspect or feature of the present subject matter is directed to an improved process for issuing an air traveler having at least one booked air travel reservation a refund after the booked air traveler modifies or cancels the booked air travel reservation.

The improved process includes several steps. One step includes accessing a reservation system including a plurality of computers. The reservation system includes a user interface operatively connected to each computer. Each computer is operatively connected to a digital platform system 200. Digital platform system 200 includes a user registration component 204, data storage component 208, cancellation queue provisions 210, a controller component 214, a processor component 216, and a power source 218.

Registration with the digital platform system 200 by a user is a prerequisite to accessing the digital platform system 200. Another step includes accessing the digital platform system 200 to select a booked air travel reservation of a registered air traveler for modification or cancellation. For instance, instead of departing at 11:00 pm, a booked air traveler registered with the digital platform system 200 may want to change the scheduled departure time to 9:00 am the next day. Or a registered user may want to cancel a booked air flight reservation entirely. Yet another step of the improved process includes transferring the selected booked travel reservation to the cancellation queue provisions to designate the selected booked reservation for repurposing. After the selected booked reservation goes into the cancellation queue, a new air travel inventory is generated, which becomes available to be matched to the search criteria of a booking air traveler. Another improved process step includes receiving from a booking air traveler registered with the digital platform system 200 a search criterion for a desired air travel reservation.

Another step of the improved process includes querying the digital platform system 200 as to whether a desired air travel reservation of the booking traveler matches a new generated air travel inventory, corresponding to a reservation designated by the booked air traveler for repurposing in the cancellation queue provisions 210. When there is a match, yet another step of the improved process includes enabling a booking air traveler to purchase the new air travel inventory and the associated new air travel reservation.

After the booking air traveler purchases the new air travel inventory which includes at least one associated new air travel reservation, another step of the improved process includes canceling the reservation designated by the booked air traveler for repurposing in the cancellation queue provisions. After the booked reservation designated for repurposing is canceled, another step includes issuing the booked air traveler a refund for the canceled air travel reservation designated by the booked traveler for repurposing.

For the improved process for issuing an air traveler having a booked air travel reservation a refund after modifying or cancelling his/her booked air travel reservation, the booked air traveler registered with the digital platform system receives either a full or a partial refund. At least one of the computers is selected from the group consisting of a desktop, a laptop, and a smart device. The smart device is selected from the group consisting of a tablet device and a smart phone device. Also, the digital platform system is operatively connected to a mobile device having a network connection selected from the group consisting of a cellular connection, a LAN connection, and a Wi-Fi connection.

### Digital Platform System

In addition, the present subject matter is directed to a digital platform system 200 (FIG. 7) comprising communication receiving provisions 202 adapted and configured for receiving data input into the digital platform system 200 by a user. The digital platform system 200 also includes a registration component 204 operatively connected to the communication receiving provisions 202. The registration component 204 enables at least a portion of the data input to be used to register a user with the digital platform system 200. Digital platform system 200 includes a data storage component 208 operatively connected to the communication receiving provisions 202 and the registration component 204, for storing user data input for registration including at least one booked air travel reservation of the registered user. Digital platform system 200 also includes cancellation queue provisions 210 operatively connected to each of the communication receiving provisions 202, the registration component 204, and the data storage component 208. The cancellation queue provisions 210 are adapted and configured for receiving at least one booked air flight reservation selected for repurposing. Digital platform system 200 further includes a controller component 214 and a processor component 216. The controller component 214 and the processor component 216 are both operatively connected to each of the registration component 204, the data storage component 208, and the cancellation queue provisions 210, for enabling a registered user to select for repurposing a booked air travel reservation from the data storage component 208 for transfer to the cancellation queue provisions 210. In context, the term “repurposing” when used in connection with a booked air travel reservation shall be understood throughout this patent specification to include modifying or cancelling a booked air travel reservation.

The digital platform system 200 includes communication transmitting provisions 212 operatively connected to the controller component 214 and the processor component 216, for outputting data relating to the repurposed air travel reservation after it is modified or canceled. The digital platform system 200 also includes an internal power source 218.

### Improved Air Fare Reservation System

An improved air fare reservation system 300 of the present subject matter includes the digital platform system 200. The digital platform system (FIG. 7) includes a registration component 204 adapted and configured to enable at least a portion of data input by a user to be used to register the user with the digital platform system 200. The digital platform system 200 also includes a data storage component 208 operatively connected to the registration component 204, for storing data input for the user for registration with the system 200. The data input by the registered user includes at least one booked air travel reservation of the registered user. Digital platform system 200 includes cancellation queue provisions 210 operatively connected to the registration component 204 and to the data storage component 208. The cancellation queue provisions 210 are adapted and configured to receive at least one booked air flight reservation selected for repurposing.

Digital platform system 200 also includes a controller component 214 operatively connected to the data storage component 208 and the cancellation queue provisions 210, for enabling the registered user to select for repurposing a booked air travel reservation stored in the data storage component 208. The term “repurposing” a booked air travel reservation, as used throughout this patent specification, shall be understood as including modifying or cancelling the originally booked air travel reservation of the booked traveler.

Digital platform system 200 includes communication transmitting provisions 212 operatively connected to the controller component 214. The communication transmitting provisions 212 are adapted and configured for outputting modification or cancellation data relating to at least one repurposed air travel reservation after it is modified or canceled.

The improved air fare reservation system 300 includes at least one global distribution system (GDS) 350 operably connected via a cloud-based infrastructure 400 (including, e.g., a computer server-farm based system) to the digital platform system 200;

The improved air fare reservation system 300 includes a plurality of computers 320A, 320B, 320C, . . . 320N operatively connected to the at least one global distribution system (GDS) 350. In addition, each of the plural computers 320A, 320B, 320C, . . . 320N is operatively connected to an associated user interface 330A, 330B, 330C, . . . 330N.

The improved air fare reservation system 300 of the present subject matter includes a first digital device 360 and a second digital device 370. Each digital device 360 and 370 is operatively connected by means of the cloud-based infrastructure 400 to the digital platform system 200. The first digital device 360 of the two digital devices 360, 370 includes a screen 365 on which a new or modified air travel reservation and its associated new or modified flight itinerary can be displayed. The second digital device 370 of the two digital devices 360, 370 is operatively connected to at least one conventional printer 380. The conventional printer 380 is adapted and configured for printing a new or modified air travel reservation 390 as well as an associated new or modified air travel itinerary 395.

Described in this patent specification and illustrated by the associated figures is a digital platform system including communication receiving provisions adapted and configured for receiving data input into the digital platform system, also including a user registration component that is operatively connected to the communication receiving provisions, and further including a data storage component that is operatively connected to the communication receiving provisions and the registration component for storing user data input for registration purposes. The data includes a booked air travel reservation of a registered user. The digital platform system includes cancellation queue provisions that are operatively connected to the communication receiving provisions, the registration component, and the data storage component. The cancellation queue provisions are adapted and configured to receive at least one booked air flight reservation selected for repurposing. Also described in detail in this patent specification is an improved process for issuing an air traveler having at least one booked air travel reservation a refund, full or partial, for unused air travel reservation when travel plans change. While the present subject matter is described in relation to current embodiments, the scope of the present subject matter is not limited to the embodiments disclosed. Indeed, many alternatives, changes, or modifications will become apparent to a person of ordinary skill in the art (“POSITA”) after this patent specification and its figures are reviewed. Therefore, all such alternatives, changes, and modifications are to be viewed as forming a part of the present subject matter insofar as they fall within the spirit and the scope of the appended claims.

I claim:

1. An improved process for issuing an air traveler having a booked air travel reservation a refund after the booked air traveler modifies or cancels the booked air travel reservation, wherein the improvement comprises:
accessing a reservation system comprising a plurality of computers, wherein the reservation system includes a user interface operatively connected to each computer, wherein each computer is operatively connected to a digital platform system, wherein the digital platform system includes a user registration component, a data storage component, and cancellation queue provisions, wherein registration with the digital platform system is a prerequisite to accessing the digital platform system;
accessing the digital platform system to select a booked air travel reservation of a registered air traveler for modification or cancellation;
transferring the selected booked air travel reservation to the cancellation queue provisions to designate the selected booked reservation for repurposing;
receiving from a booking air traveler registered with the digital platform system a search criterion for a desired air travel reservation;
querying the digital platform system as to whether the desired air travel reservation of the booking traveler matches the reservation designated by the booked air traveler for repurposing in the cancellation queue provisions;
when there is a match, generating in the digital platform system a new travel itinerary associated with a new air travel reservation, for enabling the booking air traveler to purchase the new air travel itinerary and the associated new air travel reservation;
after the booking air traveler purchases the new air travel itinerary and the associated new air travel reservation, canceling the reservation designated by the booked air traveler for repurposing in the cancellation queue provisions; and
after the booked reservation designated for repurposing has been canceled, issuing the booked air traveler a refund for the canceled air travel reservation designated by the booked air traveler for repurposing.

2. The improved process of claim 1, wherein the booked air traveler registered with the digital platform system receives a full refund.

3. The improved process of claim 1, wherein the booked air traveler registered with the digital platform system receives a partial refund.

4. The improved process of claim 1, wherein the at least one of the plurality of computers is selected from a group consisting of a desktop, a laptop, and a smart device.

5. The improved process of claim 4, wherein the smart device is selected from the group consisting of a tablet device and a smart phone device.

6. The improved process of claim 1, wherein the digital platform system is operatively connected to a mobile device having a network connection selected from the group consisting of a cellular connection, a LAN connection, and a Wi-Fi connection.

7. A digital platform system (200) comprising:
communication receiving provisions (202) adapted and configured for receiving data input into the digital platform system (200) by a user;
a registration component (204) operatively connected to the communication receiving provisions (202), wherein the registration component (204) enables at least a portion of the data input to be used to register a user with the digital platform system;
a data storage component (208) operatively connected to the communication receiving provisions (202) and the registration component (204) for storing user data input for registration including at least one booked air travel reservation of the registered user;
cancellation queue provisions (210) operatively connected to each of the communication receiving provisions (202), the registration component (204), and the data storage component (208), wherein the cancellation queue provisions are adapted and configured for receiving at least one booked air flight reservation selected for repurposing;
a controller component (214) and a processor component (216), wherein the controller component (214) and the processor component (216) are both operatively connected to each of the registration component (204), the data storage component (208) and the cancellation queue provisions (210), for enabling the registered user to select for repurposing a booked air travel reservation from the data storage component (208) for transfer to the cancellation queue provisions (210), wherein repurposing a booked air travel reservation includes modifying or cancelling the booked air travel reservation; and
communication transmitting provisions (212) operatively connected to each of the controller component (214) and the processor component (216), for outputting data relating to the repurposed air travel reservation after it is modified or canceled.

8. The digital platform system (200) of claim 7, including a power source (218).

9. An improved air fare reservation system (300) comprising:
a digital platform system (200) comprising:
a registration component (204) adapted and configured to enable at least a portion of data to be used to register a user with the digital platform system;
a data storage component (208) operatively connected to the registration component (204), for storing data input for user registration, wherein the data includes a booked air travel reservation of the registered user;
cancellation queue provisions (210) operatively connected to each of the registration component (204) and the data storage component (208), wherein the cancellation queue provisions (210) are adapted and configured to receive the booked flight reservation selected for repurposing;
a controller component (214) operatively connected to the cancellation queue provisions (210) and the data storage component (208), for enabling the registered user to select for repurposing a booked reservation stored in the data storage component (208), wherein repurposing a booked air travel reservation includes modifying or cancelling the booked reservation; and
communication transmitting provisions (212) operatively connected to the controller component (214), for outputting modification or cancellation data relating to a repurposed air travel reservation after it is modified or canceled;
at least one global distribution system (350) operably connected by a cloud-based system (400) to the digital platform system (200);
a plurality of computers (320A, 320B, 320C, . . . 320N) operatively connected to the at least one global distribution system (350), wherein each one of the plural computers (320A, 320B, 320C, . . . 320N) is operatively connected to an associated user interface (330A, 330B, 330C, . . . 330N); and
a first digital device (360) and a second digital device (370), wherein the digital devices (360, 370) are operatively connected by the cloud-based system (400) to the digital platform system (200).

10. The improved reservation system (300) of claim 9, wherein a first digital device (360) of the two digital devices includes a screen (365) on which a new or modified air travel reservation and/or one or more associated boarding passes can be displayed.

11. The improved reservation system (300) of claim 9, further including a printer (380) operably connected to a second digital device (370) selected from the two digital devices, wherein the printer (380) is adapted and configured for printing a new or modified air travel reservation (390) and one or more associated boarding passes (395).

12. The improved reservation system of claim 9, wherein the booked air traveler registered with the digital platform system receives a full refund after a booking air flight traveler registered with the digital platform system pays for the repurposed flight.

13. The improved reservation system of claim 9, wherein the booked air traveler registered with the digital platform system receives a partial refund after a booking air flight traveler registered with the digital platform system pays for the repurposed flight.
